(19) United States
(12) Patent Application Publication
(10) Pub. No.: US 2013/0112783 A1
(43) Pub. Date: May 9, 2013

(54) HOSE ADAPTER

(71) Applicant: Christopher I. JOHNSON, Nokomis, FL (US)

(72) Inventor: Christopher I. JOHNSON, Nokomis, FL (US)

(21) Appl. No.: 13/672,440

(22) Filed: Nov. 8, 2012

Related U.S. Application Data
(60) Provisional application No. 61/557,212, filed on Nov. 8, 2011.

(51) Int. Cl. B05B 1/00

(52) U.S. Cl. CPC B05B 1/00
USPC 239/589

(57) ABSTRACT

A nozzle adapter has a first end with a coupling and a body extending longitudinally from the coupling. A flow of fluid through the adapter is limited to a system pressure and flow rate upon activation of the nozzle adapter. The nozzle adapter is activated by temporarily limiting the fluid flow at an outlet of the body, which substantially forces all air out of the nozzle adapter and replaces the air with the fluid.

### BACKGROUND OF THE INVENTION

1. Field of the Invention

This invention relates to hose nozzles and more specifically to a manually actuatable device that provides for a slowing fluid flow exiting the nozzle, without having to remove the nozzle from the hose.

2. Description of the Related Art

Garden hoses are commonly known devices. To direct a water stream from the hose end in a variety of patterns such as a jet stream or a cone shaped spray, screw-on hose nozzles have been devised. Typical hose nozzles are either barrel type hose nozzles or pistol-grip hose nozzles.

A barrel type hose nozzle is usually in the form of a generally cylindrical body. One end of the body is adapted to be connected to the garden hose and the opposite end defines the nozzle from which the water stream exits. The body has a forward cylindrical element, which may be retracted or extended in relation to a rear cylindrical element by rotating the forward cylindrical element. The pattern of the water stream issuing from the nozzle is adjusted by rotating the forward cylindrical element into different positions. The flow rate of the water stream issuing from the nozzle is also related to the position of the forward cylindrical element.

A typical pistol-grip nozzle includes a tubular body having a handle portion connectable at one end to the hose. The body has a fixed barrel portion extending from the opposite end of the hose connector at an angle similar to the angle between the handle and barrel of a pistol. The water stream issues from the nozzle at the forward end of the barrel. The pattern and flow rate of the water stream is determined by a valve stem extending through the barrel portion and outwardly through the rear end thereof. The movement of the stem is controlled by a pivoted actuating lever or trigger, which includes a portion generally parallel with the handle of the nozzle body enabling the user to grip the handle portion and actuating lever and to adjust the water stream issuing from the nozzle by a simple squeezing action. The flow rate of the water stream exiting from the nozzle is also related to the position of the valve stem.

In both the barrel and piston nozzles, the stream varying structure is moved into and out of its fully closed position from and into any operating position. The range of adjustment allows for variation of the water stream pattern issuing from the nozzle orifice and the flow rate.

When using both a barrel and pistol hose nozzle for either creating a misting action or using the full blast action, water is forced through a small opening creating a quick, forceful movement of the water as it leaves the end of the hose nozzle. There is an inability to control the flow of water coming out of a hose nozzle to a slower more gentle flow of water as the water leaves the end of the hose nozzle. The only solution to this problem is to remove the hose nozzle from the end of the hose, obtaining the natural gentle flow of water coming out of the end of the hose and then put the hose nozzle back on the end of the hose to create the harder, more forceful flow of water.

### SUMMARY OF THE INVENTION

According to one embodiment of the invention, a nozzle is provided that allows a user to slow the flow of fluid exiting the nozzle without having to remove the nozzle from the hose.

The present nozzle adapter solves the problems of over-spray and back-spray while using a standard barrel or pistol nozzle. While disclosed as an adapter, the adapter can be incorporated into a barrel or pistol nozzle.

According to one embodiment of the invention, the Slow Flow™ nozzle adapter is a 4 inch cylindrical attachment added to the end of the nozzle. When activated, the force of the fluid exiting the nozzle is neutralized turning the fluid flow into a gentle, steady flow, substantially the same as it flows out of the end of a hose when the water nozzle is removed. This provides for a change of the fluid flow from a hard, forceful spray of water to a gentle, soft flow of water with one simple touch. Adding the Slow Flow™ nozzle adapter to the end of a typical hose nozzle enables a user to control or slow the flow of water.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a cross section of the nozzle adapter; and

FIG. 2 is an end view of the nozzle adapter.

### DETAILED DESCRIPTION OF THE PRESENTLY PREFERRED EMBODIMENTS

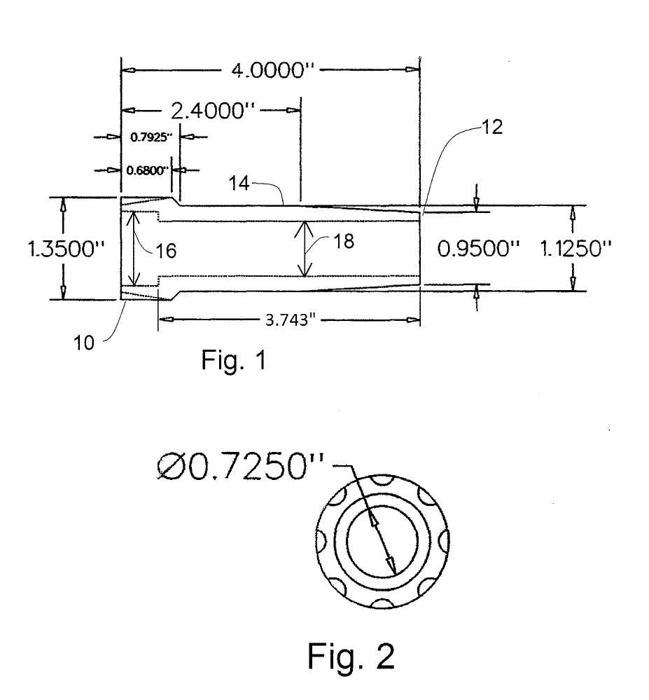

FIG. 1 is a cross section of the device according to one embodiment of the invention. As shown adapter 1 has a first end 10 configured to attach to a hose. Water exits from second end 12. In a preferred embodiment, the adapter 1 is 4 inches long and an internal diameter of body 14 is about 0.725 inches. An inner length of the body 14 approximately 3.743 inches.

In normal operation the water exits the Slow Flow™ nozzle adapter device 1 with the pressure and spray pattern generated by the nozzle. By applying a very slight amount of pressure to the end 12 of the Slow Flow™ nozzle adapter device 1, a water lock occurs removing substantially all of the air from within the Slow Flow™ device and replacing the air with the flowing fluid. This causes a damming effect thereby slowing the flow of water. The slow fluid flow mimics the flow of water from the hose without a nozzle. Slowing the flow of fluid from the hose nozzle provides many beneficial uses and completely changes the way a conventional hose nozzle is used.

The nozzle adapter 1 has a first end with a coupling and a body extending longitudinally from the coupling. A flow of fluid through the adapter is limited to a system pressure and flow rate upon activation of the nozzle adapter. The nozzle adapter is activated by temporarily limiting the fluid flow at an outlet of the body, which substantially forces all air out of the nozzle adapter and replaces the air with the fluid.

The adapter 1 can be used to clean boats, fishing, and diving gear. In harsh marine environments the washing and cleaning tasks require both the higher pressure created by a water nozzle to blast off fish blood and grime and a slow flow of water to rinse the expensive fishing and diving gear, washing hands, filleting fish, washing around expensive marine electronics, companionways, and more. The Slow Flow™ nozzle adapter device 1 enables a user to quickly and easily switch between these two discharge modes.

Typical hose nozzles enable a user to create a jet like force of water from the hose when fully activated or a lighter misting force as the off position is approached. Either option creates a forceful flow of water causing back resistance on the nozzle. When the Slow Flow™ nozzle adapter 1 is attached to the end of a nozzle, the user has the same benefits of a water nozzle but adds a second feature improving the function and use of a hose nozzle. When the Slow Flow™ nozzle adapter device 1 is activated, the flow of water instantly changes the forceful back resistant flow to a gentle near zero resistant flow of water. As a result, the use of the water nozzle is greatly improved. When the Slow Flow™ nozzle adapter 1 is deactivated, the nozzle can be use in its conventional manner. The Slow Flow™ nozzle adapter device 1 provides better control the fluid coming out of the water nozzle.

In one embodiment, the overall length of the Slow Flow™ nozzle adapter device 1 is 4 inches. The hose end 10 of the Slow Flow™ nozzle adapter device 1 has approximately a 1 inch inner diameter 16 and the body 14 has a 0.725 inch inner diameter 18. In one embodiment, the inner diameter of the body is 0.75 inches. The length of the Slow Flow™ nozzle adapter 1 is selected such that the water flow is not impeded by the overall length. For a typical garden hose, the 4 inch length is preferable. The ratio of length to inner diameter is preferably maintained at about 5.5:1 so that the Slow Flow™ nozzle adapter 1 functions as designed. The inner length of the Slow Flow™ nozzle adapter 1 is selected such that the water flow is not impeded by the overall length. For a typical garden hose, the inner length is about 3.743 inches. The ratio of inner length to inner diameter is preferably maintained at about 5.2:1 so that the Slow Flow™ nozzle adapter 1 functions as designed. In a preferred embodiment, adapter 1 is made from 3M MGABS Rod Material.

The Slow Flow™ nozzle adapter 1 is a 4 inch cylinder that attaches to the end of a conventional hose nozzle. The inside diameter of the Slow Flow™ nozzle adapter device 1 is about the same as the outside diameter of the hose nozzle. When fluid exits the nozzle, through Slow Flow™ nozzle adapter 1, the flow is essentially the same as if the Slow Flow™ nozzle adapter device 1 was not attached to the hose nozzle. The spraying action of the water is forced through the inner portion of the Slow Flow™ nozzle adapter device 1 with air on either side of the water stream inside the Slow Flow™ nozzle adapter 1. It does not matter if the spray nozzle is activated for minimal flow or if the nozzle is activated to achieve full flow, air remains within the Slow Flow™ nozzle adapter device 1 until it is activated.

The Slow Flow™ nozzle adapter device 1 attached to the hose nozzle eliminates the fanning-out spray (overspray) that occurs when the nozzle on or off allowing the direction of the water where it is wanted. This elimination of overspray is a result of the length of the Slow Flow™ nozzle adapter device 1 shielding the water from fanning out by concentrating the flow of water in the direction the hose nozzle is pointed. This is an additional advantage due to the nature of the Slow Flow design and is a benefit when washing cars or boats in tight or windy areas.

To activate the Slow Flow™ nozzle adapter device 1 a user gently places a thumb or any item (ground, tire, towel, leg, car, pet or even a pool or bucket of water) on the end 12 where the fluid is exiting the Slow Flow™ nozzle adapter device 1. The pressure against the end 12 of the Slow Flow device 1 causes the water to “back up” within the Slow Flow™ nozzle adapter device 1 forcing all of the air out of the Slow Flow device 1. This elimination of air within the Slow Flow™ nozzle adapter device 1 creates a damming affect at the very point where water leaves the hose nozzle and enters the Slow Flow™ nozzle adapter device 1. As a result, the force of water leaving the hose nozzle is eliminated resulting in a “slow flow” of water coming out of the end of the Slow Flow™ nozzle adapter device 1, which mimics the water exiting the hose if no nozzle were in place. When the Slow Flow™ nozzle adapter device 1 is activated, the flow of water is the same as if the water was gently coming out of the end of a hose without a hose nozzle attached.

To deactivate the Slow Flow™ nozzle adapter device 1 simply turn the hose nozzle off and then back on. The air is then reintroduced, eliminating the damming effect, and the hose nozzle essentially works as if the Slow Flow™ nozzle adapter device 1 was not attached with the added benefit of no overspray.

The Slow Flow adapter is a very simple device and it will not scratch or mar any surface. There are no moving parts. It is durable and will last a lifetime. It is inexpensive to manufacture. It does not even need a washer to work. It works because of the design. The length is the key dimension. Given a fixed inner diameter, making the Slow Flow device 1 a longer or shorter reduces its effectiveness.

Using the Slow Flow™ nozzle adapter device 1 to fill a water holding tank eliminates the back pressure of a typical nozzle that will blow a standard nozzle out of the fill hole every time. After activating the Slow Flow™ nozzle adapter device 1, the water tank fills with no back-spray, mess, or wasted water.

The Slow Flow™ nozzle adapter device 1 makes filling a bucket full of soapy water, not suds very easy. The Slow Flow™ nozzle adapter device 1 is activated by dropping it in the bucket and the water gently mixes with the soap leaving a perfect soap bucket to use to wash a car, boat, or RV. This is also great to wash just the tires and not the whole vehicle. Additionally, by controlling the water output, it is easier to water a lawn and then easily change the flow to watering small delicate plants. Once activated, the Slow Flow™ nozzle adapter device 1 can be used to fill a pool without the snake effect and water squirting out of control. Additionally, chemicals (weed killer, insecticides, and the like) can be mixed in a pressure sprayer without having to remove the hose nozzle from the hose.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed:

1. A nozzle adapter comprising:
a first end having a coupling; and
a body extending longitudinally from the coupling,
wherein a flow of fluid through the adapter is limited to a system pressure and flow rate upon activation.

2. The nozzle adapter of claim 1, wherein the nozzle adapter is activated by temporarily limiting the fluid flow at an outlet of the body, whereby substantially all air is forced out of the nozzle adapter and replaced by the fluid.

3. The nozzle adapter of claim 2, wherein the body has an inner diameter of about 0.725 inches.

4. The nozzle adapter of claim 3, wherein the nozzle adapter has an overall length of about 4 inches.
